(19) United States
(12) Patent Application Publication
(10) Pub. No.: US 2016/0137814 A1
(43) Pub. Date: May 19, 2016

(54) LOW-EMISSION, STABILIZED POLYURETHANE

(71) Applicant: BASF SE, Ludwigshafen (DE)

(72) Inventors: Iran OTERO MARTINEZ, Stemwede (DE); Stefan BOKERN, Bakum (DE)

(73) Assignee: BASF SE, Ludwigshafen (DE)

(21) Appl. No.: 14/899,923

(22) PCT Filed: Jun. 10, 2014
(86) PCT No.: PCT/EP2014/061961

§ 371 Date: Dec. 18, 2015

(30) Foreign Application Priority Data
Jun. 19, 2013 (EP) 13172832.1

(51) Int. Cl. C08K 5/3435; C08K 5/101

(52) U.S. Cl. CPC C08K 5/3435; C08K 5/101

(57) ABSTRACT

The present invention relates to a process for preparing polyurethanes, in which (a) polyisocyanate, (b) polymeric compounds with groups that are reactive towards isocyanates, (c) catalysts, (d) 0.01 to 1% by weight of an aliphatic hydrocarbon (d1) having 2 to 15 carbon atoms which comprise at least one heteroatom selected from the group consisting of oxygen, nitrogen and sulfur, and at least one chlorine or bromine atom, and/or phosphoric acid ester (d2), (e) antioxidants and/or light stabilizers and optionally (f) blowing agents, (g) chain extenders and/or crosslinking agents and (h) auxiliaries and/or additives are mixed to give a reaction mixture and the reaction mixture is allowed to fully react to give the polyurethane, where the phosphoric acid ester corresponds to the general formula (R¹—O)₃—P═O, where the three radicals R¹, independently of one another, are organic radicals which comprise one or more phenyl groups, one or more phosphoric acid groups (polyalkyl phosphate with ethylene oxide) or esters thereof and/or one or more atoms selected from the group consisting of nitrogen, oxygen, fluorine, chlorine and bromine. Furthermore, the present invention relates to polyurethanes obtainable by a process according to the invention and to the use of these polyurethanes in the interior of means of transport.

The present invention relates to a process for preparing polyurethanes, in which (a) polyisocyanate, (b) polymeric compounds with groups that are reactive towards isocyanates, (c) catalysts, (d) 0.01 to 1% by weight of an aliphatic hydrocarbon (d1) having 2 to 15 carbon atoms which comprise at least one heteroatom selected from the group consisting of oxygen, nitrogen and sulfur, and at least one chlorine or bromine atom, and/or phosphoric acid ester (d2), (e) antioxidants and/or light stabilizers and optionally (f) blowing agents, (g) chain extenders and/or crosslinking agents and (h) auxiliaries and/or additives are mixed to give a reaction mixture and the reaction mixture is allowed to fully react to give the polyurethane, where the phosphoric acid ester corresponds to the general formula (R¹—O)₃—P═O, where the three radicals R¹, independently of one another, are organic radicals which comprise one or more phenyl groups, one or more phosphoric acid groups (polyalkyl phosphate with ethylene oxide) or esters thereof and/or one or more atoms selected from the group consisting of nitrogen, oxygen, fluorine, chlorine and bromine. Furthermore, the present invention relates to polyurethanes obtainable by a process according to the invention and to the use of these polyurethanes in the interior of means of transport.

Polyurethanes are characterized by diverse use possibilities. These are often used in particular in automobile construction on account of their diverse properties. High demands are placed on polyurethanes which are used in the automobile sector. Thus, excellent mechanical properties are demanded which do not alter over the life of the automobile so that the polyurethanes, according to the area of use, do not lose either their function in daily use, for example the upholstering properties, haptic properties, or stabilization properties. In this connection, polyurethanes for automobile applications are exposed to extreme climatic conditions, such as solar irradiation, humidity and extreme temperatures in the range from less than −10° C. to 100° C., which increase the rate of the aging of the polyurethane.

These considerable burdens to the plastics requires stabilization of the polyurethanes through the addition of additives, such as UV and light stabilizers and antioxidants. However, the addition of these stabilizers leads to emissions which can be perceived in the automobile as an odor nuisance. Particularly parts which serve both as exterior components and therefore have to be stabilized particularly against the impact of UV and humidity, but which also extend into the automobile interior, such as seals for windows, pose a problem as a result of their high stabilizer content and thus high emissions. Polyurethanes for use as seal material for glass windows, in particular for automobiles and the production thereof are known and described, for example, in U.S. Pat. No. 5,421,940, U.S. Pat. No. 5,362,428, U.S. Pat. No. 6,228,305, WO 98/14492, EP 355209 and EP 1577080.

It was therefore the object of the present invention to reduce the emissions of highly stabilized polyurethanes without adversely affecting the mechanical properties and the aging properties of these plastics.

The object according to the invention has surprisingly been achieved by a polyurethane obtainable by a process in which (a) polyisocyanate, (b) polymeric compounds with groups that are reactive towards isocyanates, (c) catalysts, (d) 0.01 to 1% by weight of an aliphatic hydrocarbon (d1) having 2 to 15 carbon atoms which comprise at least one heteroatom selected from the group consisting of oxygen, nitrogen and sulfur, and at least one chlorine or bromine atom, and/or phosphoric acid ester (d2), (e) antioxidants and/or light stabilizers and optionally (f) blowing agents, (g) chain extenders and/or crosslinking agents and (h) auxiliaries and/or additives are mixed to give a reaction mixture and the reaction mixture is allowed to fully react to give the polyurethane, where the phosphoric acid ester corresponds to the general formula (R¹—O)₃—P═O, where the three radicals R¹, independently of one another, are organic radicals which comprise one or more phenyl groups, one or more phosphoric acid groups (polyalkyl phosphate with ethylene oxide) or esters thereof and/or one or more atoms selected from the group consisting of nitrogen, oxygen, fluorine, chlorine and bromine.

In particular, they are preferably polyurethanes with a density of at least 400 g/l, preferably 850 to 1500 g/l and particularly preferably 950 to 1350 g/l. Particular preference is given to massive polyurethanes. Here, a massive polyurethane is essentially obtained without adding a blowing agent. Small amounts of blowing agent, for example water, which is present in the polyols as a consequence of production, do not count here as blowing agent. Preferably, the reaction mixture for preparing the compact polyurethane comprises less than 0.2% by weight, particularly preferably less than 0.1% by weight and in particular less than 0.05% by weight of water.

The polyisocyanate components (a) used for preparing the polyurethanes according to the invention comprise all polyisocyanates known for preparing polyurethanes. These comprise the aliphatic, cycloaliphatic and aromatic di- or polyvalent isocyanates known from the prior art, as well as any desired mixtures thereof. Examples are 2,2′-, 2,4′- and 4,4′-diphenylmethane diisocyanate, the mixtures of monomeric diphenylmethane diisocyanates and higher nucleic homologs of diphenylmethane diisocyanate (polymer-MDI), isophorone diisocyanate (IPDI) or oligomers thereof, 4,4′-diisocyanatodicyclohexylmethane (H₁₂MDI) or oligomers thereof 2,4- or 2,6-tolylene diisocyanate (TDI) or mixtures thereof, tetramethylene diisocyanate or oligomers thereof, hexamethylene diisocyanate (HDI) or oligomers thereof, naphthalene diisocyanate (NDI) or mixtures thereof.

Preference is given to using 2,4- and/or 2,6-tolylene diisocyanate (TDI) or mixtures thereof, monomeric diphenylmethane diisocyanates and/or higher nucleic homologs of diphenylmethane diisocyanate (polymer-MDI) and mixtures thereof. Further possible isocyanates are given for example in “Kunststoffhandbuch [Plastics Handbook], volume 7, Polyurethanes”, Carl Hanser Verlag, 3rd edition 1993, chapter 3.2 and 3.3.2.

The polyisocyanate component (a) can be used in the form of polyisocyanate prepolymers. These polyisocyanate prepolymers are obtainable by reacting previously described polyisocyanates (constituent (a-1)) in excess, for example at temperatures of from 30 to 100° C., preferably at about 80° C., with polymeric compounds having groups that are reactive towards isocyanates (b) (constituent (a-2)) and/or chain extenders (c) (constituent (a-3)) to give the isocyanate prepolymer.

Polymeric compounds with groups that are reactive towards isocyanates (a-2) and chain extenders (a3) are known to the person skilled in the art and are described for example in the “Kunststoffhandbuch [Plastics Handbook], 7, Polyurethanes”, Carl Hanser-Verlag, 3rd edition 1993, chapter 3.1. Thus, for example, polymeric compounds with groups that are reactive towards isocyanates (a-2) that can be used are also the polymeric compounds having groups that are reactive towards isocyanates described below under (b).

Polymeric compounds having groups that are reactive towards isocyanates (b) that can be used are all known compounds with at least two hydrogen atoms that are reactive towards isocyanates, for example those with a functionality of from 2 to 8 and a number-average molecular weight of from 400 to 15 000 g/mol. Thus, for example, compounds selected from the group of polyether polyols, polyester polyols or mixtures thereof can be used.

Polyetherols are prepared, for example, from epoxides, such as propylene oxide and/or ethylene oxide, or from tetrahydrofuran with hydrogen-active starter compounds, such as aliphatic alcohols, phenols, amines, carboxylic acids, water or compounds based on natural materials, such as sucrose, sorbitol or mannitol, using a catalyst. Mention is to be made here of basic catalysts or double-metal cyanide catalysts, as described for example in PCT/EP2005/010124, EP 90444 or WO 05/090440.

Polyesterols are prepared e.g. from aliphatic or aromatic dicarboxylic acids and polyhydric alcohols, polythioether polyols, polyester amides, hydroxyl-group-containing polyacetals and/or hydroxyl-group-containing aliphatic polycarbonates, preferably in the presence of an esterification catalyst. Further possible polyols are given for example in the “Kunststoffhandbuch [Plastics Handbook], volume 7, Polyurethanes”, Carl Hanser Verlag, 3rd edition 1993, chapter 3.1.

Besides the described polyetherols and polyesterols, filler-containing polyetherols or polyesterols, also referred to as polymer polyetherols or polymer polyesterols, can also be used. Such compounds preferably comprise dispersed particles of thermoplastic polymers, for example composed of olefinic monomers, such as acrylonitrile, styrene, (meth)acrylates, (meth)acrylic acid and/or acrylamide. Such filler-containing polyols are known and commercially available. Their preparation is described for example in DE 111 394, U.S. Pat. No. 3,304,273, U.S. Pat. No. 3,383,351, U.S. Pat. No. 3,523,093, DE 1 152 536, DE 1 152 537, WO 2008/055952 and WO 2009/128279.

In a particularly preferred embodiment of the present invention, the component (b) comprises polyetherols and further preferably no polyesterols.

Catalysts c) increase the rate of the reaction of the polyols (b) and optionally chain extenders and crosslinking agents (f), and chemical blowing agent (e) with the organic, optionally modified polyisocyanates (a) to a considerable extent. In this connection, customary catalysts for preparing the polyurethanes can be used. By way of example, mention may be made of amidines, such as 2,3-dimethyl-3,4,5,6-tetrahydropyrimidine, tertiary amines, such as triethylamine, tributylamine, dimethylbenzylamine, N-methyl-, N-ethyl-, N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl)urea, dimethylpiperazine, 1,2-dimethylimidazole, 1-aza-bicyclo(3.3.0)-octane and preferably 1,4-diazabicyclo(2.2.2)-octane and alkanolamine compounds, such as triethanolamine, triisopropanolamine, N-methyl- and N-ethyldiethanolamine and dimethylethanolamine. Likewise of suitability are organic metal compounds, preferably organic tin compounds, such as tin(II) salts of organic carboxylic acids, e.g. tin(II) acetate, tin(II) octoate, tin(II) ethylhexoate and tin(II) laurate and the dialkyltin(IV) salts of organic carboxylic acids, e.g. dibutyltin diacetate, bibutyltin dilaurate, dibutyltin maleate and dioctyltin diacetate, and also bismuth carboxylates, such as bismuth(III) neodecanoate, bismuth 2-ethylhexanoate and bismuth octanoate or mixtures thereof. The organic metal compounds can be used on their own or preferably in combination with strongly basic amines. If the component (b) is an ester, preferably exclusively amine catalysts are used.

Further, known incorporable amine catalysts can be used. These have at least one, preferably 1 to 8 and particularly preferably 1 to 2 groups that are reactive towards isocyanates, such as primary amine groups, secondary amine groups, hydroxyl groups, amides or urea groups. Incorporable amine catalysts are mostly used for preparing low-emission polyurethanes which are used in particular in the automobile interior. Such catalysts are known and described for example in EP1888664. If the emissions are to be further reduced, exclusively incorporable catalysts are used as catalysts (c) or mixtures of incorporable and nonincorporable catalysts.

If catalysts (c) are used, these can be used for example in a concentration of from 0.001 to 5% by weight, in particular 0.05 to 2% by weight, as catalyst or catalyst combination, based on the weight of component (b).

To prepare the polyurethane according to the invention, the compound (d) used is one or more aliphatic hydrocarbons (d1) having 2 to 15 carbon atoms which comprises at least one heteroatom selected from the group consisting of oxygen, nitrogen and sulfur, and at least one chlorine or bromine atom, and/or phosphoric acid ester (d2). In this connection, it is possible to use in each case individual substances or mixtures, where the total fraction of the compounds (d1) and (d2) is 0.01 to 2% by weight, preferably 0.02 to 1% by weight and in particular 0.05 to 0.5% by weight, in each case based on the total weight of components (a) to (h).

Component (d1) used is aliphatic hydrocarbons having 2 to 15, preferably 3 to 10, further preferably 3 to 6 and in particular 3 to 4 carbon atoms which comprise at least one heteroatom selected from the group consisting of oxygen, nitrogen and sulfur, and at least one bromine and/or chlorine atom, preferably 2, 3 or 4 bromine and/or chlorine atoms, particularly preferably 2 or 3 bromine and/or chlorine atoms. In a further preferred embodiment, the compound (d1) comprises only one bromine or chlorine atom. As bromine and/or chlorine atom, the aliphatic hydrocarbon (d1) preferably comprises chlorine. In this connection, the content of bromine and/or chlorine atoms, particularly preferably of chlorine, is preferably at least 20% by weight, particularly preferably at least 30% by weight and in particular at least 40% by weight, in each case based on the total weight of component (d1). Preferably, the aliphatic hydrocarbon (d1) comprises at least one bromine and/or chlorine atom which is bonded to a primary carbon atom.

The aliphatic hydrocarbon (d1) here can be linear, branched-chain or cyclic and is preferably linear or branched-chain. In this connection, the heteroatom can be present at the end or in the middle of the chain as bridging atom. Examples of heteroatoms in the middle of the chain are ether groups —O—, thioether groups —S— or tertiary nitrogen groups. If at least one heteroatom is present in the middle of the chain, then it is preferably an ether group. Instead of the bridging atom or in addition to the bridging atom, the aliphatic hydrocarbon (d1) comprises at least one group which has hydrogen atoms that are reactive towards isocyanate groups. Such groups are, for example, —SH groups, —NH groups, —NH₂ groups or —OH groups. Particularly preferably, the compound (d) has at least one OH group. Further preferably, the aliphatic hydrocarbon (d1) has a bridging atom in addition to the —OH group, particularly preferably at least one ether group. In a particularly preferred embodiment, there are no more than 3 carbon atoms, preferably no more than 2 carbon atoms, between the bromine and/or chlorine atom and the heteroatom. In particular, the compound (d1) comprises an OH group, preferably on the adjacent carbon atom to the carbon atom which carries the bromine or chlorine atom. Here, the aliphatic hydrocarbon (d1) comprises no phosphoric acid ester, polyphosphate, phosphonic acid ester or phosphorus acid ester, and preferably the aliphatic hydrocarbon (d1) comprises no phosphorus atoms.

Aliphatic hydrocarbons (d1) according to the invention preferably have a boiling temperature under standard conditions of at least 100, particularly preferably at least 120 and in particular at least 150° C.

Examples of preferred aliphatic hydrocarbons (d1) are 1,3-dichloro-2-propanol, 1,1,1-trichloro-2-methyl-2-propanol hemihydrate, 2-[2-(2-chloroethoxy)ethoxy]ethanol, 2-(2-chloroethoxy)ethanol, bis(2-(2-chloroethoxy)ethyl)ether, 1,2-dichloro-3-propanol, 3-chloro-1-propanol, 3-chloro-2,2,dimethyl-1-propanol, 1-chloro-2-propanol, 2-chloro-1-propanol, 3-bromo-1-propanol, 4-chloro-1-butanediol, 5-chloro-1-pentanol and 6-chloro-1-hexanol. Particular preference is given to 1,3-dichloro-2-propanol, 1,2-dichloro-3-propanol, 1-chloro-2-propanol and 3-chloropropanol, in particular 1,3-dichloro-2-propanol, 1-chloro-2-propanol and 3-chloropropanol.

Component (d2) comprises phosphoric acid esters. These preferably have a molecular weight of at least 350 g/mol. Preference is likewise given to phosphoric acid esters (d2) which have at least one group that is reactive towards isocyanates, for example OH group.

Here, the phosphoric acid esters used are those esters of phosphoric acid which correspond to the general formula

(R¹—O)₃—P═O

where the three radicals R¹, independently of one another, are organic radicals which comprise one or more phenyl groups, one or more phosphoric acid groups or esters thereof and/or one or more atoms selected from the group consisting of nitrogen, oxygen, fluorine, chlorine and bromine. In this connection, the radicals R¹ comprise in each case, independently of one another, preferably 1 to 20, particularly preferably 2 to 10 and in particular 2 to 5 carbon atoms and may be aromatic, branched or linear. Preferably, the radicals are aliphatic. Preference is given to radicals which have chlorine atoms or oxygen atoms, for example as OH end groups. Examples of the radicals R¹ are ethylene chloride, propylene chloride, butylene chloride, ethylene oxide, propylene oxide, butylene oxide and polyethylalkylene oxides having preferably 2 to 10 repeat units.

Preferably, the phosphoric acid esters (d2) according to the invention comprise at least two, preferably two to 50, particularly preferably 2 to 20, phosphate groups in a molecule which are linked by polyvalent radicals, in particular by divalent radicals —R″—. Here, R″ is an organic radical having 1 to 20, preferably 2 to 10 and in particular 2 to 5 carbon atoms, which may be aromatic or aliphatic, preferably aliphatically linear or branched, preferably branched, and optionally comprise one or more atoms selected from the group consisting of nitrogen, oxygen, fluorine, chlorine and bromine. The phosphoric acid esters according to the invention comprise, for example, 2,2-bis(chloromethyl)trimethylene bis(bis(2-chloroethyl)phosphate), tris(2-butoxyethyl)phosphate, tris(1,3-dichloro-2-isopropyl)phosphate tris(2-chloroisopropyl)phosphate and oligomeric alkyl phosphates with ethyleneoxide bridges, such as Fyrol® PNX from ICL Industrial Products.

Antioxidants and/or light stabilizers (e) which can be used are all antioxidants and light stabilizers known for polyurethane. These comprise hindered amine light stabilizers, so-called HALS (Hindered Amine Light Stabilizer), which have one or more 2,2,6,6-tetramethyl piperidine units as structural unit. Such compounds can be acquired for example under the trade names Uvinul® 5050 H, Uvinul® 4077 H, Tinuvin® 770, UV-77, JPT, Sabostab® UV 70, Sanol® LS-770, Adekastab® LA-77, HS-770, Uvinul® 4050 H Uvinul® 4077 H, Tinuvin® 622, Sabostab® UV 62, Uvinul® 5062 H, Chisorb® 622; Tinuvin® 144, Tinuvin® 765, Tinuvin® 292, Tinuvin® 123, Tinuvin® 5100, Chimassorb® 119, Chimassorb® 944, Adekastab® LA-94, Sanol® LS 944, Tinuvin® 783, Tinuvin® XT 833, Mark LA52 Fl, or Adekastab® LA-52. Besides hindered amines, compounds with one or more of the general structural units selected from the group consisting of benzophenone, benzotriazole, cyanoacrylate, cinnamate, oxanilide, formamidine, triazine, benzylidenemalonate can be used as light stabilizers, in particular against UV radiation. Examples of these compounds are available under the trade names Uvinul® 3008, Chimassorb® 81, CH81 DRIED, Kemisorb® 12, Seesorb® 102, Adekastab® 1413, Adekastab® LA-51, Viosorb® 130, Uvinul® 3026, Tinuvin® 326, Tinogard® AS, Kemisorb® 73, Seesorb® 703, Adekastab® LA-36, Viosorb® 550, Sumisorb® 300, UV-730, Tomisorb® 600, Uvinul® 3027, Tinuvin® 327, Kemisorb® 72, Seesorb® 702, Adekastab® LA-34, Viosorb® 580, UV-750, Tomisorb® 700, Uvinul® 3028, BLS 1328, Cyasorb® UV-2337, Tinuvin® 328, Kemisorb® 74, Seesorb® 704, Viosorb® 591, Sumisorb® 350, Uvinul® 3029, Tinuvin® 329, UV5411, Kemisorb® 79, Seesorb® 709, Viosorb® 583, Sumisorb® 340, Uvinul® 3033 P, BLS 1710, Kingsorb® 71, Tinuvin® P, Kemisorb® 71, Seesorb® 701, Adekastab® LA-32, Viosorb® 520, Sumisorb® 200, UV-710, Tomisorb® 100, Uvinul® 3030, Uvinul® 3035, Uvinul® 3039, Uvinul® N 539 T, Uvinul® 3088, Tinosorb® OMC, Uvinul® MC 80 N, Tinuvin® 213, Eversorb® 80, Tinuvin® 234, Uvinul® 3034, Tinuvin® 900, Eversorb® 234, Seesorb® 706, Viosorb® 590, Sumisorb® 590, Tinuvin® 312, Sanduvor® VSU Powder, Tinuvin® 571, Tinuvin® 171, Tinogard® TL, Additive NX Tinubin®571, Chisorb® 971, Tinuvin® 101, Zikasorb® R, Additive TS 3111, Cyasorb® 1164, Uvinul® 3000, Sanduvor® PR25, Hostavin® PR25, NEPA, Tinuvin® 384, Tinuvin® 99, Eversorb® 81, CGL 384 Distilled, Tinuvin® 1577, Tinuvin® 360, Tinosorb® MBBT, Lowilite® 36, Tinuvin® 320, Kemisorb® 75, Seesorb® 705, Adekastab® LA-38, Viosorb® 582 and Sumisorb® 320.

The antioxidants used are in particular compounds which comprise one or more of the structural units selected from sterically hindered phenols, sulfides or benzoates. Here, in sterically hindered phenols, the two orthohydrogens are substituted by compounds which are not hydrogen and preferably carry at least 1 to 20, particularly preferably 3 to 15, carbon atoms and are preferably branched. Benzoates also carry, preferably in the ortho position relative to the OH group, substituents which are not hydrogen and carry particularly preferably 1 to 20, in particular 3 to 15, carbon atoms, which are preferably branched. Examples of these compounds are available under the trade names Irganox® 245 FF, Irganox® 245, Songnox® 2450 FF, Irganox® 1010, Anox® 20, Betenox® 1010, Ashland® AO 610, BNX 1010, Dovernox® 10, Irganox® L 101, Songnox® 1010, Spul-IX 1010, Tinogard® TT, VX IX 1010 ED, VXDD IX 1010 ED, Adekastab® AO-60, Sumilizer® BP-101, Tominox® TT, Irganox® 1098, Plaox®-1098, Lowinox® HD98, Chinox® 1098, Tinuvin® 144, Irganox® 1135, CA 505, Irganox® L135, Irgastab® BD 50, KPA 2399, Lubad® 668, Naugalube® 531, Naugard® PS-48, OIC 135, OX BF, Stock 3074, Irganox® 1076, BNX 1076, Anox® PP 18, Naugard® 76, Tinogard® TS, Adekastab® AO-50, Sumilizer® BP-76, Tominox® SS, Irganox® 1425, Irgamod® 195, Antioxidant 1425, Irganox® 3114, Irganox® 1330 Ethanox® 330, Kingnox® 1330, Adekastab® AO-330, Irganox® 1081, Irganox® E201, tocopherylquinone, DL-alpha-tocopherol, Irganox® PS 800, Arenox® DL, dilaurylthiodipropionate (DLTDP), Irganox® PS 802, Arenox® DS, Cyanox® STDP-SP Powder, DSTP, Kingnox® DSTDP, Irganox® 565, Tinogard® MD1, Irganox® 1035, Irganox® L115, Irganox® 1520, Irgastab® cable KV 10, Irganox® 1726, Irganox® 3052, Irganox® MD 1024, Lowinox® MD24, Thanox® MD 1024, Irgastab® MBS 11, Irgastab® PVC 11, Irgastab® PVC 11 EM, Irgastab® PUR 55, Irgastab® PUR 67, Irgastab® PUR 68, Irganox® B 1171, Irganox® B 215, Irganox® B 225, Irganox® B 220, Irganox® B 561, Irganox® B 612, Tinuvin® XT 833, Yoshinox® SR, Irganox® 415, Lowinox® TBM, Sangonox® TBMC, Tinuvin® 120, Kemisorb® 112, Seesorb® 712, Adekastab® LA-12, Viosorb® 80, Sumisorb® 400, Adekastab® AO-40, Sumilizer® BBM-S and Lowinox® 44B25.

Particularly preferably, the antioxidants and/or light stabilizers (e) used according to the invention comprise at least one ester or ether group, there being in each case one carbon atom adjacent to the oxygen atoms of the ester or ether group in the molecule of the antioxidant or the light stabilizer. Examples thereof are Uvinul® 4077 H, Tinuvin®770, UV-77, JPT, Sabostab® UV 70, Sanol® LS-770, Adekastab® LA-77, HS-770, Uvinul® 3008, Chimassorb® 81, CH81 DRIED, Kemisorb® 12, Seesorb® 102, Adekastab® 1413, Adekastab® LA-51, Viosorb® 130, Uvinul® 3030, Uvinul® 3035, Uvinul® 3039, Uvinul® N 539 T, Uvinul® 3088, Tinosorb® OMC, Uvinul® MC 80 N, Irganox® 245 FF, Irganox® 245, Songnox® 2450 FF, Tinuvin®622, Sabostab® UV 62, Uvinul® 5062 H, Chisorb® 622, Tinuvin®213, Eversorb® 80, Tinuvin®312, Cyasorb® 1164, Sanduvor® PR25, Hostavin® PR25, NEPA, Irganox® 1010, Anox® 20, Betenox®1010, Ashland® AO 610, BNX 1010, Dovernox® 10, Irganox® L 101, Songnox® 1010, Spul-IX 1010, Stock 4413, Tinogard®TT, VX IX 1010 ED, VXDD IX 1010 ED, Adekastab® AO-60, Sumilizer® BP-101, Tominox® TT, Tinuvin®144, Tinuvin®765, Tinuvin® 292, Irganox® 1135, CA 505, Irganox® L135, Irgastab® BD 50, KPA 2399, Lubad® 668, Naugalube® 531, Naugard® PS-48, OIC 135, OX BF, Stock 3074, Tinuvin®384, Tinuvin®99, Eversorb® 81, Irganox® 1076, BNX 1076, Anox® PP 18, Naugard® 76, Tinogard® TS, Adekastab® AO-50, Sumilizer BP-76, Tominox® SS, Tinuvin®1577, Tinuvin®123, Tinuvin®5100, Irganox® PS 800, Arenox® DL, dilaurylthiodipropionate (DLTDP), Irganox® PS 802, Arenox® DS, Cyanox® STDP-SP Powder, DSTP, Kingnox® DSTDP, Irganox® 1035, Irganox® L115, Irganox® 3052, Irgastab® PUR 67, Irgastab® PUR 68, Mark LA52 Fl, Adekastab® LA-52, Tinuvin®120, Kemisorb® 112, Seesorb® 712, Adekastab® LA-12, Viosorb® 80 and Sumisorb® 400.

The fraction of compound (e), based on the total weight of components (a) to (h), is preferably more than 0.1% by weight, particularly preferably from 0.3 to 10% by weight and in particular from 0.5 to 5% by weight.

If the polyurethane according to the invention is to be in the form of polyurethane foam, reaction mixtures according to the invention also comprise blowing agents (f). In this connection, it is possible to use all blowing agents known for preparing polyurethanes. These can comprise chemical and/or physical blowing agents. Such blowing agents are described for example in the “Kunststoffhandbuch [Plastics Handbook], volume 7, Polyurethanes”, Carl Hanser Verlag, 3rd edition 1993, chapter 3.4.5. Chemical blowing agents are understood here as meaning compounds which form gaseous products upon reaction with isocyanate. Examples of such blowing agents are water or carboxylic acids. Physical blowing agents are understood here as meaning compounds which are dissolved or emulsified in the feed materials of the polyurethane preparation and evaporate under the conditions of polyurethane formation. These are, for example, hydrocarbons, halogenated hydrocarbons and other compounds, such as, for example, perfluorinated alkanes, such as perfluorohexane, chlorofluorocarbons, and ethers, esters, ketones, acetals and/or liquid carbon dioxide. Here, the blowing agent can be used in any desired amount. The blowing agent is preferably used in an amount such that the resulting polyurethane foam has a density of 10 to 850 g/l, particularly preferably 20 to 800 g/l and in particular 25 to 500 g/l. Particular preference is given to using blowing agents comprising water. Preferably, no blowing agents (e) are used.

Chain extenders and crosslinking agents (g) which can be used are compounds with at least two groups that are reactive towards isocyanates and which have a molecular weight of less than 400 g/mol, with molecules having two hydrogen atoms that are reactive towards isocyanate being referred to as chain extenders and molecules having more than two hydrogens that are reactive towards isocyanate being referred to as crosslinkers. However, it is also possible here to dispense with the chain extender or crosslinking agent. To modify the mechanical properties, e.g. the hardness, however, the addition of chain extenders, crosslinking agents or optionally also mixtures thereof may prove to be advantageous.

If chain extenders and/or crosslinking agents (g) are used, it is possible to use the chain extenders and/or crosslinkers known in the preparation of polyurethanes. These are preferably low molecular weight compounds with functional groups that are reactive towards isocyanates, for example glycerol, trimethylolpropane, glycol and diamines. Further possible low molecular weight chain extenders and/or crosslinkers are given, for example, in the “Kunststoffhandbuch [Plastics Handbook], volume 7, Polyurethanes”, Carl Hanser Verlag, 3rd edition 1993, chapter 3.2 and 3.3.2.

Further, auxiliaries and/or additives (h) can be used. Here, is possible to use all auxiliaries and additives known for the preparation of polyurethanes. Mention may be made, for example, of surface-active substances, foam stabilizers, cell regulators, release agents, fillers, dyes, pigments, flame retardants, hydrolysis protectants, fungistatic and bacteriostatic substances. Such substances are known and described, for example, in “Kunststoffhandbuch [Plastics Handbook], volume 7, Polyurethanes”, Carl Hanser Verlag, 3rd edition 1993, chapter 3.4.4 and 3.4.6 to 3.4.11.

In general, during the preparation of the polyurethane according to the invention, feed materials are reacted in amounts such that the ratio of NCO groups of the polyisocyanates (a) to the sum of the reactive hydrogen atoms of components (b), (c), (d) and optionally (e), (f) and (g) is 0.75 to 1.5:1, preferably 0.80 to 1.25:1. If the cellular plastics comprise at least in part isocyanurate groups, a ratio of NCO groups of the polyisocyanates (a) to the sum of the reactive hydrogen atoms of component (b), (c), (d) and optionally (e) and (f) of from 1.5 to 20:1, preferably 1.5 to 8:1 is usually used. A ratio of 1:1 corresponds here to an isocyanate index of 100.

The polyurethanes according to the invention are preferably used in the interior of vehicles, such as aircraft, land vehicles or water-borne vehicles, particularly preferably in the interior of automobiles, for example as clear coating for wood or wood imitations. Particularly preferably, the polyurethanes according to the invention are used for components which extend both into the interior and also the exterior of the vehicle. One example of such an application is the use as seal for windows, in particular for glass windows, such as the windscreen of automobiles. The production of such seals is known and described for example in U.S. Pat. No. 5,421,940, U.S. Pat. No. 5,362,428, U.S. Pat. No. 6,228,305, WO 98/14492, EP 355209 and EP 1577080.

The present invention will be illustrated below by reference to examples.

### Starting Materials:

Polyol A: Polyetherol with an OH number of 27 mg KOH/g and a functionality of 2.5 based on ethylene oxide and propylene oxide, a propylene oxide content of 78% by weight and an ethylene oxide content of 21% by weight
MEG: Monoethylene glycol
Schwarzpaste: Dispersion of carbon black in polyether polyol with an OH number of 22 mg KOH/g based on ethylene oxide and propylene oxide
TEDA: Triethylenediamine
Fomrez UL32: Catalyst from GE Silicones
Irganox 1135: Antioxidant from BASF according to the formula

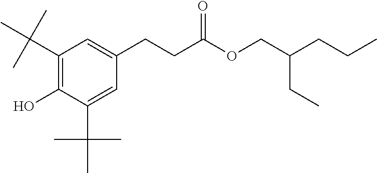 [SMILES: CCCC(CC)COC(=O)CCc1cc(C(C)(C)C)c(O)c(C(C)(C)C)c1]

Tinuvin 765: Antioxidant from BASF according to the formula

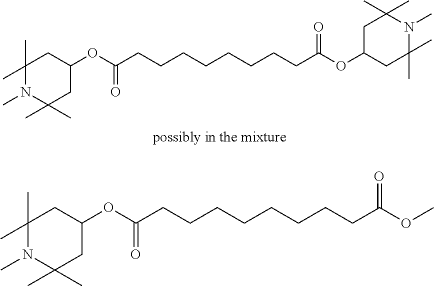

### Additive

A1: Fyrol® PNX—oligomeric phosphate ester from ICL Industrial Products
A2: 3-chloro-1-propanol
A3: 2,2-bis(chloromethyl)trimethylene bis(bis(2-chloroethyl)phosphate)
Isocyanate A: carbodiimide-modified 4,4′-MDI with an NCO content of 26.2

The mixture A was prepared by mixing the following components:

| | | |
|---|---|---|
| 84.18 | parts by weight | (pts.) polyol A |
| 9.0 | parts by weight | MEG |
| 5.0 | parts by weight | Schwarzpaste |
| 0.02 | part by weight | TEDA |
| 0.1 | part by weight | Fomrez UL32 |
| 0.4 | part by weight | Irganox 1135 |
| 1.1 | parts by weight | Tinuvin 765 |
| 0.1 | part by weight | additives A1 to A3 according to table 1 |

The mixture A and the isocyanate component A, as well as the additives according to table 1 were mixed together at an isocyanate index of 100 and placed into a closed mold such that moldings with an average density of 1050 g/l were obtained.

To determine the measurement values for the mechanical properties, the procedures were in accordance with the following standards.

| Property | Dimension | DIN standard |
|---|---|---|
| Hardness | Shore A | 53505 |
| Density | g/mm³ | 845 |

To determine the VOC and FOG values, the procedures were in accordance with VDA 278.

TABLE 1
Table 1: VOC and FOG values (ppm) according to VDA 278 of the
resulting elastomers upon addition of the respective additives A1 to A3.

| | | |
|---|---|---|
| Plates | VOC | FOG |

| Shore A 87 | Total | TEDA¹ | Total | AOX² |
|---|---|---|---|---|
| Reference | 83 | 49 | 490 | 455 |
| A1 (0.1 pts.) | 78 | 37 | 376 | 347 |
| A2 (0.1 pts.) | 79 | 32 | 360 | 329 |
| A3 (0.1 pts.) | 49 | 33 | 223 | 202 |

¹TEDA fraction in VOC
²Antioxidants fraction in FOG

1: A process for preparing a polyurethane, comprising mixing:
(a) a polyisocyanate,
(b) one or more polymeric compounds with groups that are reactive towards isocyanates,
(c) one or more catalysts,
(d) 0.01 to 1% by weight of an aliphatic hydrocarbon (d1) having 2 to 15 carbon atoms which comprises at least one heteroatom selected from the group consisting of oxygen, nitrogen and sulfur, and at least one chlorine or bromine atom, and/or a phosphoric acid ester (d2),
(e) one or more antioxidants and/or light stabilizers and optionally
(f) one or more blowing agents,
(g) one or more chain extenders and/or crosslinking agents and
(h) one or more auxiliaries and/or additives
to give a reaction mixture and the reaction mixture is allowed to fully react to give the polyurethane,
where the phosphoric acid ester has a formula
(R¹—O)₃—P═O
where the three radicals R¹, independently of one another, are organic radicals which comprise one or more phenyl groups, one or more phosphoric acid groups or esters thereof and/or one or more atoms selected from the group consisting of nitrogen, oxygen, fluorine, chlorine and bromine.

2: The process according to claim 1, wherein at least one light stabilizer is present and is a derivative of 2,2,6,6-tetramethylpiperidine (HALS).

3: The process according to claim 1, wherein at least one antioxidant is present and the antioxidant comprises at least one structural unit selected from the group consisting of benzophenone, benzotriazole, cyanoacrylate, cinnamate, sterically hindered phenol, oxanilide, formamidine, triazine, benzylidenemalonate, benzopyran, sulfide and benzoate.

4: The process according to claim 1, wherein the fraction of the antioxidants and light stabilizers, based on the total weight of the components (a) to (h), is more than 0.1% by weight.

5: The process according to claim 1, wherein the antioxidants and/or light stabilizers comprise an ester or ether group, where in each case there is one carbon atom adjacent to the oxygen atoms of the ester or ether group in the molecule of the antioxidant or of the light stabilizer.

6: The process according to claim 1, wherein the aliphatic hydrocarbon (d1) comprises a chlorine atom.

7: The process according to claim 1, wherein the aliphatic hydrocarbon (d1) and/or the phosphoric acid ester (d2) has groups that are reactive towards the polyisocyanate (a).

8: The process according to claim 1, wherein the aliphatic hydrocarbon (d1) comprises at least 30% by weight, based on the total weight of the component (d1), of chlorine and/or bromine atoms.

9: The process according to claim 1, wherein the phosphoric acid ester (d2) comprises at least two phosphate groups in the molecule.

10: The process according to claim 1, wherein the polyurethane is a compact polyurethane with an average density of more than 850 g/l.

11: A polyurethane produced by the process according to claim 1.

12. (canceled)

13: An automobile window seal comprising the polyurethane according to claim 11.
